(19) United States
(12) Patent Application Publication
(10) Pub. No.: US 2012/0054295 A1
(43) Pub. Date: Mar. 1, 2012

(54) METHOD AND APPARATUS FOR PROVIDING OR ACQUIRING THE CONTENTS OF A NETWORK RESOURCE FOR A MOBILE DEVICE

(75) Inventors: Keke Cai, Beijing (CN); Ma Rui, Beijing (CN); Zhong Su, Beijing (CN); Xiao Xun Zhang, Beijing (CN); Hui Jia Zhu, Shanghai (CN)

(73) Assignee: International Business Machines Corporation, Armonk, NY (US)

(21) Appl. No.: 13/214,385

(22) Filed: Aug. 22, 2011

(30) Foreign Application Priority Data
Aug. 30, 2010 (CN) 201010269644.2

(51) Int. Cl. G06F 15/167

(52) U.S. Cl. 709/213

(57) ABSTRACT

An apparatus and method for providing the contents of a network resource to a mobile device are disclosed, the apparatus including: an acquiring module for acquiring the current contents of the network resource; and an adaptive filtering module for extracting the difference information by comparing the cached contents of the network resource and the current contents of the network resource, and sending the difference information to the mobile device. An apparatus and method for acquiring the contents of network resource are also disclosed, the apparatus including: a determining module for determining whether a response to an access request for a network resource includes difference information; a combining module for, generating current contents of the network resource by combining the difference information and locally cached previous contents of the network resource; and a presenting module for presenting the generated current contents of the network resource.

### CROSS-REFERENCE TO RELATED APPLICATION

This application claims priority under 35 U.S.C. §119 from Chinese Patent Application No. 201010269644.2 filed Aug. 30, 2010, the entire contents of which are incorporated herein by reference.

### BACKGROUND OF THE INVENTION

1. Field of the Invention

The present invention relates to web access of mobile devices, and more particularly, to a method and apparatus for providing and acquiring the contents of a network resource for a mobile device.

2. Description of Related Art

Mobile web access refers to accessing data services such as the Internet by using mobile devices like a cellular phone, a PDA. Various information resources accessed by mobile web accesses can be referred to as network resources. A frequently used application of mobile web accesses is, for example, browsing network news from a news aggregator of a content provider by combining a web browser with a handheld mobile device. It is reported that the total number of mobile web users first exceeded that of desktop-based web users in 2008.

For common users, it is very convenient to be able to easily access the Internet at any time and any location. However, the fee for accessing the web by mobile devices is much higher than that for accessing the web by dial-up Internet connections. Information services are charged according to the service plan/service package subscribed by the user. In most cases, fees are in positive proportion with, for example, the network traffic and occupation time in a time period, for example, one month, and will increase rapidly when beyond the upper limit specified in the service plan/service package. In addition, the access speed of the mobile device becomes slower due to the limit of the network traffic of the web access, thus affecting the user's experience. Moreover, web accesses by a multitude of users' mobile devices at the same time will occupy too much network bandwidth resources.

### SUMMARY OF THE INVENTION

The inventors of the present invention find that more fees will be incurred if duplicate information is downloaded, and this will also affect the access speed and occupy too much network bandwidth resources. Accordingly, the present invention provides a method for reducing network traffic by avoiding downloading duplicate contents for the user so as to reduce fees, increase the access speed and decrease the network bandwidth resource occupation.

One aspect of the present invention provides a method for providing contents of a network resource to a mobile device, including the steps of: receiving an access request to the network resource from a user's mobile device; acquiring current contents of the network resource; comparing cached previous contents of the network resource accessed by the user and the current contents of the network resource; extracting difference information between the cached previous contents and the current contents; and sending the difference information to the user's mobile device.

Another aspect of the present invention provides a method for acquiring contents of a network resource for a mobile device, including the steps of: making an access request for a network resource; receiving a response to the access request for a network resource; determining whether the response includes difference information between previous contents of the network resource accessed by a user and current contents of the network resource; generating the current contents of the network resource by combining the difference information with the previous contents of the network resource cached on the user's mobile device when it is determined that the response includes the difference information; and presenting the generated current contents of the network resource.

Another aspect of the present invention provides an apparatus for providing contents of a network resource to a mobile device, including: a receiving module for receiving an access request to the network resource from a user's mobile device; an acquiring module for acquiring current contents of the network resource; and an adaptive filtering module for (i) comparing cached previous contents of the network resource accessed by the user and the current contents of the network resource, (ii) extracting difference information between the cached previous contents and the current contents, and (iii) sending the difference information to the user's mobile device.

Another aspect of the present invention provides an apparatus for acquiring contents of a network resource for a mobile device, including: a determining module for receiving a response to an access request for the network resource and determining whether the response includes difference information between previous contents of the network resource accessed by a user and current contents of the network resource; a combining module for generating the current contents of the network resource by combining the difference information and the previous contents of the network resource cached at the user's mobile device when it is determined that the response includes the difference information; and a presentation module for presenting the generated current contents of the network resource.

Another aspect of the present invention provides a computer readable article of manufacture tangibly embodying non-transitory computer readable instructions which, when executed, cause a computer to carry out the steps of a method for providing contents of a network resource to a mobile device, including the steps of: receiving an access request to the network resource from a user's mobile device; acquiring current contents of the network resource; comparing cached previous contents of the network resource accessed by the user and the current contents of the network resource; extracting difference information between the cached previous contents and the current contents; and sending the difference information to the user's mobile device.

The method and apparatus of the present invention can decrease the network traffic when the user downloads the contents of a network resource, so as to reduce fees, increase the speed for downloading the contents of the network resource, improve the user's experience and reduce the occupation of network bandwidth resources.

### BRIEF DESCRIPTION OF THE DRAWINGS

The appended claims set forth the inventive features which are considered characteristic of the present invention. However, the invention itself and its preferred embodiments, additional objects, features and advantages will be better understood by referring to the detailed description of the exemplary embodiments when read in conjunction with the attached drawings, in which:

FIG. 1 shows a prior art method by which a user acquires the contents of a network resource, such as news, by his/her mobile device;

FIG. 2 shows the architecture of a system according to an embodiment of the present invention;

FIG. 3 shows an apparatus for providing the contents of a network resource to a mobile device according to an embodiment of the present invention;

FIG. 4 shows an apparatus for providing the contents of a network resource to a mobile device according to another embodiment of the present invention;

FIG. 5 shows an apparatus for acquiring the contents of a network resource for a mobile device according to an embodiment of the present invention;

FIG. 6 shows a method for providing the contents of a network resource to a mobile device according to an embodiment of the present invention;

FIG. 7 shows a method for providing the contents of a network resource for a mobile device according to another embodiment of the present invention; and

FIG. 8 shows a method for acquiring the contents of a network resource for a mobile device according to an embodiment of the present invention.

### DETAILED DESCRIPTION OF THE PREFERRED EMBODIMENTS

The embodiments of the present invention will be described with reference to the accompanying drawings. In the following description, numerous details are described to enable the present invention to be fully understood. However, it is obvious to those skilled in the art that the implementation of the present invention can exclude some of these details. In addition, it should be appreciated that the present invention is not limited to the described specific embodiments. In contrast, it is contemplated to implement the present invention by using any combination of the following features and elements, no matter whether they involve different embodiments or not. Therefore, the following aspects, features, embodiments and advantages are only illustrative, rather than elements or limitations of the appended claims, unless explicitly stated otherwise in the claims.

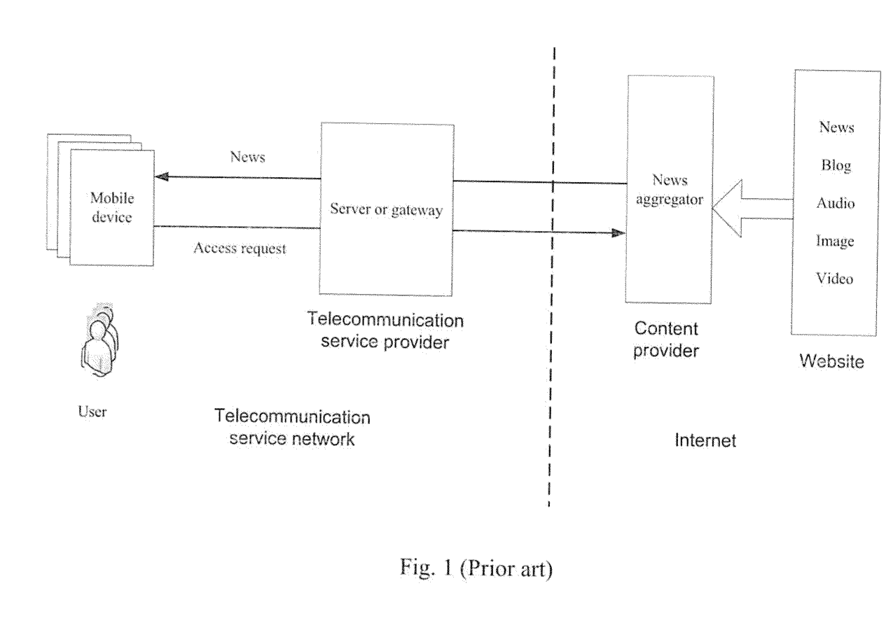

FIG. 1 shows a prior art method by which a user acquires the contents of a network resource, such as news, by a mobile device. As shown, the user uses a web-enabled mobile device, for example a cellular phone or a PDA, and sends an access request for a network resource through a telecommunication service network (including devices, such as a base station, RNC, SGSN, and GGSN, which are not shown) and devices like a server or gateway of the telecommunication service provider, to the device like a news aggregator of the content provider. The news aggregator aggregates contents (for example news, blogs, audios, images, and videos) from one or more web sites. In response to receiving the access request for a network resource from the user's mobile device, the news aggregator sends the contents of the requested network resource to the user's mobile device through a device such as the server or gateway of the telecommunication service provider and the telecommunication service network. As known by those skilled in the art, the contents provider can either be a separate entity for providing network contents to users, or can be the same entity as the telecommunication provider, or the same entity as a certain website.

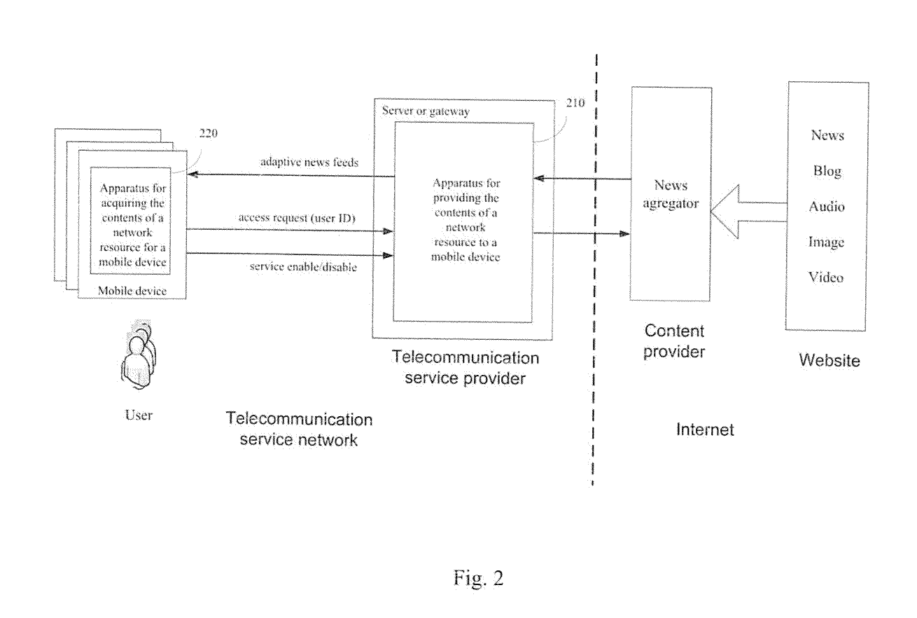

FIG. 2 shows the architecture of a system according to an embodiment of the present invention. As shown, the system according to the embodiment of the present invention includes an apparatus 210 for providing the contents of a network resource to a mobile device and an apparatus 220 for acquiring the contents of a network resource for a mobile device. The apparatus 210 for providing the contents of a network resource to a mobile device is preferably on the server or gateway of the telecommunication service provider, or can also be on a device (for example a separate device) between the server or gateway of the telecommunication service provider and the user's mobile device, and preferably behind the traffic statistics and billing facilities inside the telecommunication service provider network (that is, the user's mobile device and the apparatus 210 for providing the contents of a network resource to a mobile device are positioned at the two sides of the traffic statistics and billing facilities), so that the traffic statistics and billing facilities can measure and bill the reduced traffic generated by the apparatus 210 for providing the contents of a network resource to a mobile device of the present invention. The apparatus 220 for acquiring the contents of a network resource for a mobile device is preferably in the user's mobile device, and preferably as one or more add-ons of a web browser on the mobile device.

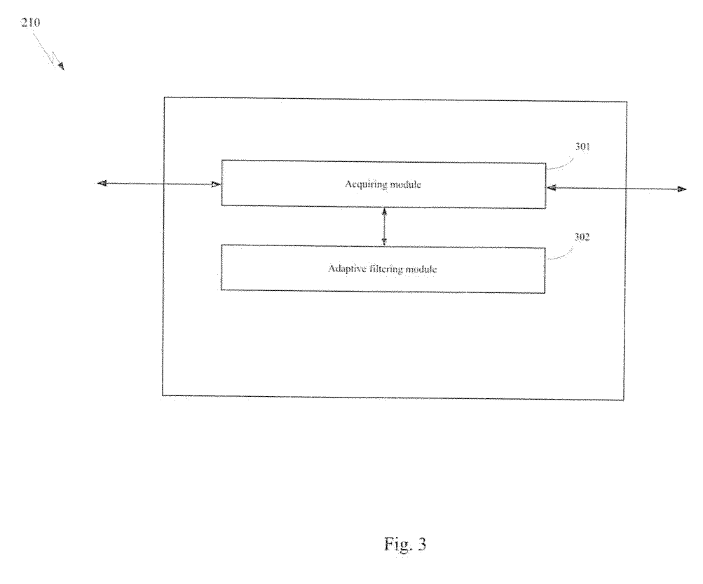

FIG. 3 shows an apparatus 210 for providing the contents of a network resource to a mobile device according to an embodiment of the present invention. As shown, the apparatus an acquiring module 301 for acquiring the current contents of the network resource in response to receiving an access request to the network resource from the mobile device of the user; and an adaptive filtering module 302 for, by comparing the cached previous contents of the network resource accessed by the user and the current contents of the network resource, extracting the difference information between the two, and sending the difference information between the two to the user's mobile device.

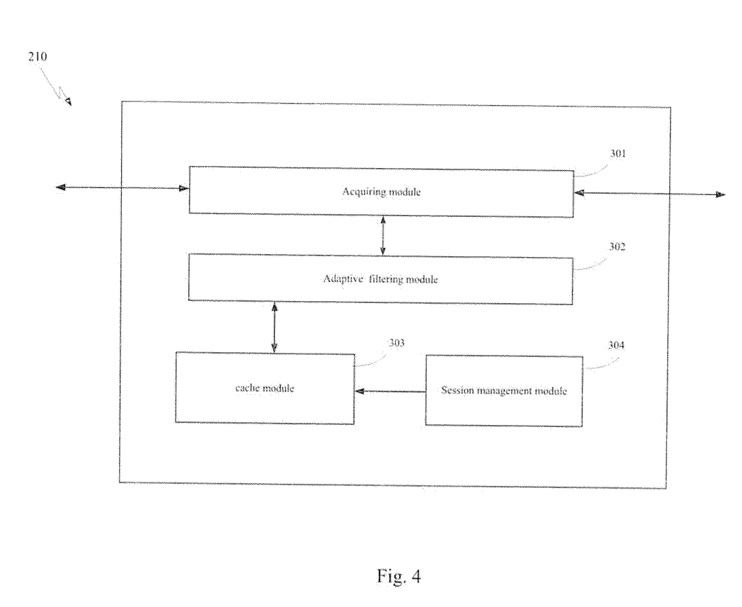

FIG. 4 shows an apparatus 210 for providing the contents of a network resource to a mobile device according to another embodiment of the present invention. As shown, the apparatus 210 for providing the contents of a network resource to a mobile device according to an embodiment of the present invention includes: an acquiring module 301 for acquiring the current contents of the network resource in response to receiving a current access request to the network resource from the user's mobile device; and an adaptive filtering module 302 for, by comparing the cached contents of the network resource (for example, cached in the cache module 303 as described below) previously accessed by the user with the current contents of the acquired network resource, extracting the difference information between the two and sending the difference information between the two to the user's mobile device.

In response to receiving the current access request to the network resource from the user's mobile device, the extracting module 301 acquires the current contents of the network resource by forwarding the current access request from the user's mobile device to the device like the news aggregator of the content provider.

According to an embodiment of the present invention, the apparatus 210 for providing the contents of the network resource to the mobile device further includes a cache module 303 for caching the acquired contents of the network resource, to be used in the comparison after receiving the access request for the network resource from the user's mobile device in the future. In an embodiment of the present invention, the cache module 303 can optionally further record a time stamp of the cached current contents of the network resource.

According to a further embodiment of the present invention, the cache module 303 is further for deleting the cached previous contents of the network resource accessed by the user. That is, the cache module 303 is further for replacing the cached contents of the network resource accessed by the user previously with the acquired current contents of the network resource, and optionally recording the time stamp of the current contents.

The cache module 303 can be a volatile or non-volatile storage device. When the acquiring module 301 acquires the contents of the network resource from a device like the news aggregator of the content provider by forwarding the access request from the user device to the device like the news aggregator of the content provider, it can store the contents into the cache module 303 for future comparison of the adaptive filtering module 302. The cache module 303 can either store the contents of each access to each network resource by each user, or merely store the contents of latest access to each network resource by each user so as to save storage space.

After the acquiring module 301 acquires the current contents of the network resource from the device like the news aggregator of the content provider by forwarding the access request for the network resource from the user device to the device like the news aggregator of the content provider, it can first determine whether previous contents of the network resource accessed by the user have been stored in the cache module 303 (for example, in the following case where the cache module 303 uses the user ID and the URL of a network resource as index to store the contents of the network resource, it can query whether previous contents of the network resource accessed by the user have been stored in the cache module according to the URL of the network resource included in the access request for the network resource from the user device and the related user ID); and if not, then before, after and at the same time of sending the current contents of the network resource to the mobile device of the user, it can store the current contents of the network resource in the cache module 303. If previous contents of the network resource have been stored in the cache module 303, then, as described below, the adaptive filtering module 302 further compares the current contents of the network resource and the previous contents of the network resource in the cache module 303 and extracts the difference information between the two, and sends the difference information (no matter whether the difference information is null or not) to the user's mobile device. Before, at the same time of or after sending the difference information to the user' mobile device, it is determined whether the difference information is null (that is, determining whether the current contents of the network resource and the previous contents of the network resource in the cache module 303 are consistent). If the difference information is not null (for example, the two are not consistent), the current contents of the network resource are stored in the cache module 303, and optionally the previous contents of the network resource that have been stored are deleted; if the difference information is null (that is, the two are consistent), then there is no need to store and delete, and optionally the time stamp is modified as the current time.

The cache module 303 can store the contents of the network resource accessed by each user in various manners. In an embodiment of the present invention, the cache module 303 can store the contents by each user and each accessed network resource. For example, the cache module 303 can use user ID and the URL of the network resource as index to store the contents of the network resource.

After receiving the access request from the user's mobile device, the adaptive filtering module 302 can use the user ID and the address of the network resource which is requested to be accessed included in the access request as the index to acquire the cached previous contents of the network resource from the cache module 303, to compare the previous contents of the network resource with the current contents of the network resource obtained from the device like the news aggregator of the content provider by the acquiring module 303, to extract the difference information between the two, and sends the extracted difference information as the response to the user's mobile device. When the cached previous contents of the network resource are consistent with the acquired current contents of the network resource, the extracted difference information between the two is null; in which case, the cache module 303 still sends the null difference information as the response to the user's mobile device. The adaptive filtering module 302 can use any document comparison method known in the art to compare the stored previous contents of the network resource with the current contents of the network resource. The document comparison method can include, for example, text comparison, image comparison, audio comparison and video comparison.

In an embodiment of the present invention, besides acquiring and sending the difference information between the current contents of the network resource requested by the user and the cached previous contents of the network resource, the adaptive filtering module 302 also extracts the structure information for positioning the difference information in the previous contents of the network resource and sends the structure information together with the difference information as the response to the user's mobile device, so that the user's mobile device can determine the position of the difference information in the contents according to the structure information. For example, for the case where the network resource is an HTML page, the structure information refers to the HTML tags for positioning the difference information in the contents of the HTML page. Since an HTML page is usually in a tree structure, the structure information can be the HTML tags at various levels from the top level HTML tag to the lowest level tag where the difference information is in the HTML page, and can further include the peer HTML tags (if any) of the HTML tags at the various levels. In such case, the adaptive filtering module 302 can send the HTML tags at various levels in the previous contents of the requested HTML page and the difference information between the current contents of the requested HTML page and the cached previous contents of the HTML page to the user's mobile device. Therefore, the user's mobile device can determine the position of the difference information (that is, the changed text) in the previous contents of the HTML page according to the HTML tags at various levels, so as to generate the current contents of the requested HTML page according to the previous contents of the HTML pages cached by itself and the difference information. Since the structure of an HTML pages is relatively stable, and the structures of the contents of different versions of an HTML page are usually the same, the user's mobile device can generate the current contents of the requested HTML page only through the locally cached contents of the HTML page and the received structure information and difference information. When the adaptive filtering module 302 determines that the structure information of the current contents of the requested HTML page has changed as compared with the structure information of the cached HTML page, the adaptive filtering module 302 can no longer acquire the difference information between the current contents of the requested HTML page and the cached contents of the HTML page, and send the current contents of the requested HTML page to the user's mobile device directly.

In another embodiment of the present invention, the adaptive filtering module 302 does not extract or send the structure information for positioning the difference information in the previous contents of the network resource, but extracts and sends the context information for positioning the difference information in the previous contents of the network resource. For example, the context information can be a piece of text before and after the difference information in the previous contents of the network resource. Thus, the user's mobile device can determine the position of the difference information in the previous contents of the network resource according to the piece of text before and after the difference information, so as to be able to generate the current contents of the requested network resource according to the previous contents of the network resource cached by itself and the difference information. Of course, it is also contemplated that the adaptive filtering module 302 extracts and sends other related information for positioning the difference information in the previous contents of the network resource.

According to an embodiment of the present invention, the adaptive filtering module 302 is further for transmitting a flag indicating the difference information together with the difference information to the user's mobile device, and the flag is transmitted in an unused field (for example, a reserved field) of the HTTP protocol header. After the user's mobile device receives the response from the apparatus 210 for providing the contents of a network resource to a mobile device according to an embodiment of the present invention, it can determine whether the response includes the difference information according to whether the unused field of the HTTP protocol header of the response includes the flag, so as to perform corresponding processing. Since the flag is transmitted in the unused field of the HTTP protocol header, the apparatus 210 for providing the contents of a network resource for a mobile device according to the embodiment of the present invention can operate by using the standard HTTP protocol without modifying the HTTP protocol. The present invention can also use other protocols other than the standard HTTP protocol.

In another embodiment of the present invention, after the acquiring module 301 receives the current access request to a network resource from the user's mobile device, it first acquires a time stamp associated with the cached previous contents of the network resource from the cache module 303 through the adaptive filtering module 302. If the difference between the time stamp and the current time is smaller than a predetermined threshold, it can be determined that the current contents of the network resource are consistent with the cached previous contents of the network resource. In this case, the adaptive filtering module 302 can directly transmit the information denoting that the contents of the network resource are not changed (for example, the null difference information as described above) to the user's mobile device, so that the user's mobile device can present its locally cached contents of the network resource as the current contents of the network resource, and without requiring the acquiring module 301 to acquire the current contents of the network resource from a device like a news aggregator of the content provider, and to compare it with the cached current contents of the network resource. If the difference between the time stamp associated with the cached previous contents of the network resource and the current time is larger than or equal to the predetermined threshold, it can be determined that the current contents of the network resource can be inconsistent with the cached previous contents of the network resource. In this case, the acquiring module 30 can obtain the current contents of the network resource from a device like a news aggregator of the content provider, and the adaptive filtering module 302 can compare it with the cached previous contents of the network resource to extract the difference information between the two, and sends the difference information to the user's mobile device. The threshold can be determined according to the expected update frequency of the network resource at the content provider. For example, if it is expected that the frequency for the content provider to update his network resource is 5 minutes, then the threshold can be set to 5 minutes.

According to an embodiment of the present invention, the apparatus 210 for providing the contents of a network resource to the mobile device further includes an optional session management module 304 for clearing the cached previous contents of the network resource accessed by the user in response to the end of the session with the user. That is, the extracting the difference information by comparing the cached previous contents network resource accessed by the user with the current contents of the acquired network resource and the sending the difference information to the user's mobile device are only applicable within a single session. Whenever a session is started, the contents of the network resource accessed by the user need to be re-cached, to be used in the comparison when the user subsequently accesses the network resource within the session. By clearing the cached previous content of the network resource accessed by the user when the session ends, storage space can be released, so that the apparatus 210 for providing the contents of a network resource to a mobile device can serve a multitude of users. The session can be of any time period, for example, several hours, a whole day, several days, starting from when the user first access a network resource within the session. In order to maintain the consistency between the previous contents of the network resource cached in the apparatus 210 for providing the contents of a network resource to mobile device and the previous contents of the network resource cached on the user's mobile device, while the cached previous contents of the network resource accessed by the user are cleared by the session management module 304, the previous contents network resource cached on the user's mobile device are also cleared. As known by those skilled in the art, this can be realized in various manners, such as by sending a command for clearing the cache to the user's mobile device while the session management module 304 clears the cached previous contents network resource accessed by the user, and executing the command by the module on the user's mobile device.

According to a further embodiment of the present invention, the session management module 304 is further for defining the session. Thus, the session can be defined as of a required time period. Each user can define his or her specific session through the session management module 304, or the administrator can define a session for all users, some users or a single user.

According to the embodiment of the present invention, optionally, the apparatus 210 for providing the contents of a network resource to a mobile device is enabled in response to an enable request from a user, and is disabled in response to receiving a disable request from a user. Thus, the operation of the apparatus can be controlled by a user, so as to satisfy different needs of different users or the same user at different times.

Above is described the apparatus 210 for providing the contents of a network resource for a mobile device according to the embodiments of the present invention. It should be pointed out that the above description is only exemplary, rather than limitation to the present invention. In other embodiments of the present invention, the apparatus can have more, less or different modules, and the functional, containment or connection relationships among the modules can be different from that is described. For example, the acquiring module 301 and the adaptive filtering module 302 can be merged into a single module; the apparatus can also include a separate receiving module for receiving the access request to a network resource from the user's mobile device and the response from a device like a news aggregator of the content provider, a transmission module for forwarding the access request to the network resource from the user's mobile device to the device like the news aggregator of the content provider and transmitting the contents including the difference information or the requested network resource to the user's mobile device. All these variations are within the spirit and scope of the present invention.

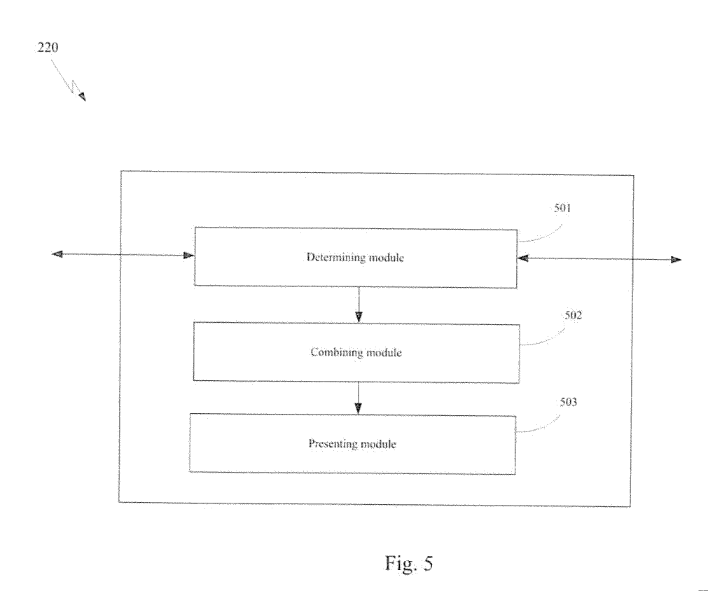

FIG. 5 describes an apparatus 220 for acquiring the contents of a network resource for a mobile device according to an embodiment of the present invention. As shown, the apparatus 220 for acquiring the contents of a network resource for a mobile device includes: a determining module 501 for receiving a response to the current access request for a network resource, and determining whether the response includes the difference information between previous contents of the network resource accessed by the user and the current contents of the network resource; a combining module 502 for, in response to the determination being yes, combining the difference information with the previous contents of the network resource cached on the user's mobile device to generate the current contents of the network resource; and a presenting module 503 for presenting the generated contents of the network resource.

According to an embodiment of the present invention, the determining module 501 determines whether the response includes the difference information between the contents of the network resource accessed previously by the user and the current contents of the network resource by determining whether the unused field of the HTTP protocol header includes a flag indicating the difference information.

According to the embodiments of the present invention, besides including the difference information between the contents of the network resource accessed previously by the user and the current contents of the network resource, the response to the current access request of the network resource also includes the structure information or context information for positioning the difference information in the previous contents of the network resource. Moreover, the combining module 502 can combine the difference information with the contents of the network resource cached on the user's mobile device according to the structure information or context information, so as to generate the current contents of the network resource currently requested to be accessed by the user. The structure information is, for example, relevant HTML tags in the HTML page.

According to an embodiment of the present invention, when the determining module 501 determines the response does not include the difference information through, for example, the fact that the unused field in the HTTP protocol header does not include the flag, but includes the complete contents of the network resource requested to be accessed, the presenting module 503 directly presents the complete contents of the network resource requested to be accessed.

The presenting module 503 can be a presenting module in an existing web browser.

As described above, an apparatus 220 for acquiring the contents of a network resource for a mobile device according to an embodiment of the present invention can exist as one or more add-ons of a web browser. As known by those skilled in the art, a web browser of a mobile device usually has the local caching ability for locally caching the contents of the latest accessed network resource, so as to enable the combining module 502 to generate the current contents of the network resource currently requested to be accessed by the user according to the received difference information and the locally cached contents of the latest accessed network resource.

Above is described an apparatus 220 for acquiring the contents of a network resource for a mobile device according to an embodiment of the present invention by referring to the accompanying drawing. It should be pointed out that the above description is only exemplary, rather than limitation to the present invention. In other embodiments of the present invention, the device can have more, less or different modules, and the functional, containment and connection relationships among the modules can be different from that is described. For example, the determining module 501 and the combining module 502 can be merged into a single module; the presenting module 503 can be excluded from the apparatus. All these variations are within the spirit and scope of the present invention.

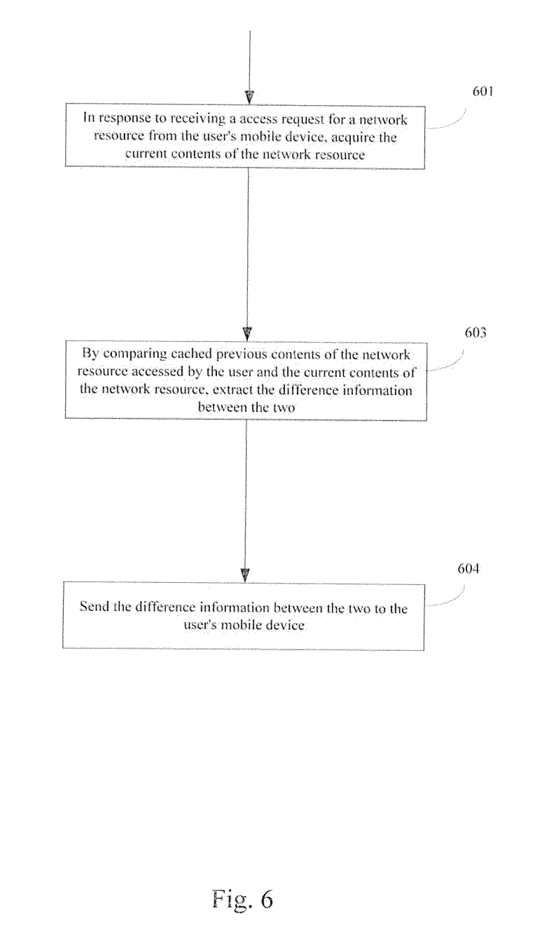

FIG. 6 describes a method for providing the contents of a network resource to a mobile device according to an embodiment of the present invention. The method can be executed by the apparatus 210 for providing the contents of a network resource to a mobile device according to the embodiment of the present invention as described. For simplicity, some details repetitive with the above descriptions are omitted in the following description. Therefore, a more detailed understanding of the method can be obtained by referring to the above description. As shown, the method includes the following steps:

At step 601, in response to receiving an access request for a network resource from the user's mobile device, the current contents of the network resource are acquired.

At step 603, by comparing the cached previous contents of the network resource accessed by the user with the current contents of the network resource, the difference information between the two is extracted.

At step 604, the difference information between the two is sent to the user's mobile device.

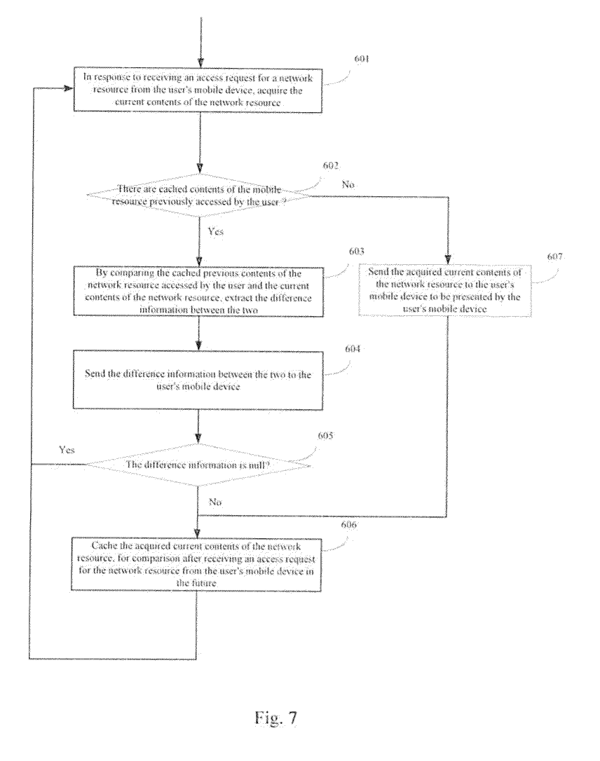

FIG. 7 describes a method for providing the contents of a network resource to a mobile device according to another embodiment of the present invention. The method can be executed by the apparatus 210 for providing the contents of a network resource to a mobile device according to the embodiment of the present invention as described above. For simplicity, some details repetitive with the above description are omitted in the following description. Therefore, a better understanding of the method can be obtained by referring to the above description. As shown, the method includes the following steps:

At step 601, in response to receiving a current access request for a network resource from the user's mobile device, the current contents of the network resource are acquired.

At step 602, it is determined whether there are cached previous contents of the network resource accessed by the user.

If the determination is yes, step 603 is performed; otherwise, step 607 is performed.

At step 603, by comparing the cached previous contents of the network resource accessed by the user and the current contents of the network resource, the difference information between the two is extracted.

At step 604, the difference information between the two is sent to the user's mobile device, so that the user's mobile device can generate and present the current contents of the network resource according to the difference information and the previous contents of the network resource cached at the user's mobile device.

According to an embodiment of the present invention, sending the difference information between the two to the user's mobile device further includes sending the structure information or context information for positioning the difference information in the previous contents of the network resource to the user's mobile device.

According to an embodiment of the present invention, sending the difference information between the two to the user's mobile device further includes sending a flag indicating the difference information together with the difference information to the user's mobile device, and the flag is sent in an unused field of the HTTP protocol header.

In the case that the cached contents of the network resource accessed by the user previously and the acquired current contents of the network resource are completely identical, i.e., the difference information is null, the null difference information can still be sent to the user's mobile device, so that the user's mobile device can generate the current contents of the network resource according to the null difference information and the contents of the network resource cached at the user's mobile device, and in which case, the generated current contents of the network resource and the contents of the network resource cached at the user' mobile device are the same.

At Step 605, it is determined whether the difference information is null.

If the determination is yes, return to step 601 to process new access requests from the user's mobile device. Furthermore, optionally, the time stamp of the cached contents of the network resource is modified to the time stamp of the current time.

If the determination is no, perform step 606, in which the acquired current contents of the network resource are cached for the comparison after receiving a new access request for the network resource from the user's mobile device in the future. Furthermore, optionally, the time stamp of the cached current contents of the network resource is recorded. Then, return to step 601 to process new access requests from the user's mobile device.

According to an embodiment of the present invention, before, after or at the same time of caching the acquired current contents of the network resource, the cached previous contents of the network resource accessed by the user are deleted, i.e., replacing the cached previous contents of the network resource accessed by the user with the current contents of the network resource. That is, only the latest accessed contents of the network resource are cached.

At step 607, the acquired current contents of the network resource are sent to the user's mobile device to be presented by the user's mobile device. Then, return to step 601 to process new access requests from the user's mobile device.

In another embodiment of the present invention, after receiving the current access request for the network resource from the user's mobile device, first the time stamp associated with the cached previous contents of the network resource is checked. If the difference between the time stamp and the current time is smaller than a predetermined threshold, it is determined that the current contents of the network resource are consistent with the cached previous contents of the network resource. In this case, information indicating that the contents of the network resource remain unchanged (for example, the above null difference information) is sent to the user's mobile device, so that the user's mobile device can present the locally cached contents of the network resource as the current contents of the network resource, without performing the above steps 601-607. If the difference between the time stamp associated with the cached previous contents of the network resource and the current time is larger than or equal to the predetermined threshold, it is determined that the current contents of the network resource and the cached previous contents of the network resource can not be consistent. In this case, the above steps 601-607 can be performed.

According to an embodiment of the present invention, the method can further include the following optional steps: in response to the session with the user ends, the cached previous contents of the network resource accessed by the user are cleared. This step can be performed before, after or together with any of the above steps.

According to an embodiment of the present invention, the method can further include the following optional steps: define a session. This step can be performed before, after or together with any of the above steps.

According to an embodiment of the present invention, the method is enabled in response to receiving an enable request from the user, and is disabled in response to receiving a disable request from the user.

According to an embodiment of the present invention, the method is performed on a server or gateway of the telecommunication service provider.

Above is described a method for providing the contents of a network resource to a mobile devices according to embodiments of the present invention by referring to FIG. 6 and FIG. 7. It should be pointed out that, the above description is only exemplary, rather than limitation to the present invention. In other embodiments of the present invention, the method can have more, less or different steps, and the order and containment relationships among the steps can be different from that is described or illustrated. For example, the order between step 606, 607 can be different from that is described or illustrated, and they can also be performed at the same time, and step 604 can be performed after or between steps 605, 606, and can also be performed together with the steps 605 or 606. All these variations are within the spirit and scope of the present invention.

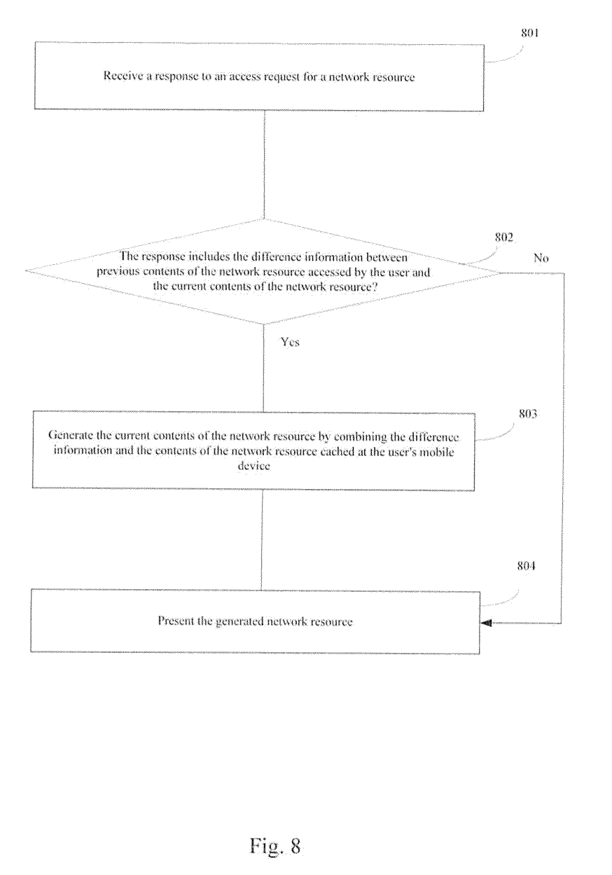

FIG. 8 describes a method for acquiring the contents of a network resource for a mobile device according the present invention. The method is preferably performed on a user's mobile device. As shown, the method includes the following steps:

At step 801, the response to an access request for a network resource is received.

At step 802, it is determined whether the response includes the difference information between the previous contents of the network resource accessed by the user and the current contents of the network resource.

According to an embodiment of the present invention, the determination is carried out by determining whether a flag indicating the difference information is included in an unused HTTP protocol header.

At step 803, in response to the determination being yes, the current contents of the network resource are generated by combining the difference information and the previous contents of the network resource cached at the user's mobile device. As described above, when the difference information is null, the generated current contents of the network resource and the contents of the network resource cached at the user's mobile device are consistent.

At step 804, the generated current contents of the network resource are presented.

According to an embodiment of the present invention, in response to the determination being no in step 802 so as to determine that the response contains the content of the network resource, step 804 is performed to present the current contents of the network resource.

Above is described the method for acquiring the contents of a network resource for a mobile device according to embodiments of the present invention by referring to FIG. 8. It should be pointed out that, the above description is only exemplary, rather than limitation to the present invention. In other embodiments of the present invention, the method can have more, less or different steps, and the order and containment relationships among the steps can be different from that is described and illustrated.

The present invention can be realized in hardware, software, or a combination thereof. The present invention can be realized in a computer system in a centralized manner, or in a distributed manner, in which, different components are distributed in some interconnected computer system. Any computer system or other devices suitable for executing the method described herein are appropriate. A typical combination of hardware and software can be a computer system with a computer program, which when being loaded and executed, controls the computer system to execute the method for the present invention, and constitute the apparatus of the present invention.

The present invention can also be embodied in a computer program product, which can realize all the features of the method described herein, and when being loaded into a computer system, can execute the method.

Although the present invention has been illustrated and described with reference to the preferred embodiments, those skilled in the art will understand that various changes both in form and details can be made thereto without departing from the spirit and scope of the present invention.

1. A method for providing contents of a network resource to a mobile device, comprising the steps of:
receiving an access request to the network resource from a user's mobile device;
acquiring current contents of the network resource;
comparing cached previous contents of the network resource accessed by the user and the current contents of the network resource;
extracting difference information between the cached previous contents and the current contents; and
sending the difference information to the user's mobile device.

2. The method of claim 1, further comprising:
caching the acquired current contents of the network resource.

3. The method of claim 2, wherein caching the acquired current contents of the network resource comprises:
replacing the cached previous contents of the network resource with the acquired current contents.

4. The method of claim 1, further comprising:
clearing the cached previous contents of the network resource accessed by the user when a session with the user ends.

5. The method of claim 1, wherein sending the difference information further comprises:
sending structure information or context information to the user's mobile device,
wherein the structure information or context information is for positioning the difference information in the previous contents of the network resource.

6. The method of claim 1, wherein the difference information is sent to the user's mobile device with a flag indicating the difference information.

7. The method of claim 1, wherein the acquiring, the extracting and the sending steps are performed in response to determining that the difference between a time stamp associated with the cached previous contents of the network resource accessed by the user and the current time is at least equal to a predetermined threshold, and the method further comprises:
sending information indicating that the contents of the network resource are not changed to the user's mobile device if it is determined that the difference between the time stamp associated with the cached previous contents of the network resource accessed by the user and the current time is smaller than the predetermined threshold.

8. A method for acquiring contents of a network resource for a mobile device, comprising the steps of:
making an access request for a network resource;
receiving a response to the access request for a network resource;
determining whether the response includes difference information between previous contents of the network resource accessed by a user and current contents of the network resource;
generating the current contents of the network resource by combining the difference information with the previous contents of the network resource cached on the user's mobile device when it is determined that the response includes the difference information; and
presenting the generated current contents of the network resource.

9. The method of claim 8, wherein determining whether the response includes the difference information between the previous contents of the network resource accessed by the user and the current contents of the network resource is carried out by determining whether a flag indicating the difference information is included in an unused field in a HTTP protocol header.

10. An apparatus for providing contents of a network resource to a mobile device, comprising:
a receiving module for receiving an access request to the network resource from a user's mobile device;
an acquiring module for acquiring current contents of the network resource; and
an adaptive filtering module for (i) comparing cached previous contents of the network resource accessed by the user and the current contents of the network resource, (ii) extracting difference information between the cached previous contents and the current contents, and (iii) sending the difference information to the user's mobile device.

11. The apparatus of claim 10, further comprising:
a caching module for caching the current contents of the network resource.

12. The apparatus of claim 11, wherein the caching module is for replacing the previous contents of the network resource accessed by the user with the acquired current contents.

13. The apparatus of claim 10, further comprising:
a session management module for clearing the cached previous contents of the network resource accessed by the user when a session with the user ends.

14. The apparatus of claim 10, wherein the adaptive filtering module is for sending structure information or context information to the user's mobile device,
wherein the structure information or context information is for positioning the difference information in the previous contents of the network resource.

15. The apparatus of claim 10, wherein the adaptive filtering module is for sending a flag indicating the difference information together with the difference information to the user's mobile device.

16. The apparatus of claim 10, wherein the acquiring module and the adaptive filtering module perform their respective operations in response to determining that the difference between a time stamp associated with the cached previous contents of the network resource accessed by the user and the current time is at least equal to a predetermined threshold, and the adaptive filtering module is further for:
sending information indicating that the contents of the network resource are not changed to the user's mobile device upon determining that the difference between the time stamp associated with the cached previous contents of the network resource accessed by the user and the current time is smaller than the predetermined threshold

17. An apparatus for acquiring contents of a network resource for a mobile device, comprising:
a determining module for receiving a response to an access request for the network resource and determining whether the response includes difference information between previous contents of the network resource accessed by a user and current contents of the network resource;
a combining module for generating the current contents of the network resource by combining the difference information and the previous contents of the network resource cached at the user's mobile device when it is determined that the response includes the difference information; and
a presentation module for presenting the generated current contents of the network resource.

18. The apparatus of claim 17, wherein the determining module determines whether the response includes the difference information between the previous contents of the network resource accessed by the user and the current contents of the network resource by determining whether a flag indicating that the response includes the difference information is included in an unused field of a HTTP protocol header.

19. A computer readable article of manufacture tangibly embodying non-transitory computer readable instructions which, when executed, cause a computer to carry out the steps of a method for providing contents of a network resource to a mobile device, comprising the steps of:
receiving an access request to the network resource from a user's mobile device;
acquiring current contents of the network resource;
comparing cached previous contents of the network resource accessed by the user and the current contents of the network resource;
extracting difference information between the cached previous contents and the current contents; and
sending the difference information to the user's mobile device.
